(19) United States
(12) Patent Application Publication
(10) Pub. No.: US 2012/0162247 A1
(43) Pub. Date: Jun. 28, 2012

(54) ELECTRONIC APPARATUS AND OBJECT DISPLAY METHOD

(75) Inventor: Tatsuyoshi NOMA, Tokyo (JP)

(73) Assignee: KABUSHIKI KAISHA TOSHIBA, Tokyo (JP)

(21) Appl. No.: 13/335,640

(22) Filed: Dec. 22, 2011

(30) Foreign Application Priority Data
Dec. 24, 2010 (JP) 2010-288820

(51) Int. Cl. G09G 5/00

(52) U.S. Cl. 345/619

(57) ABSTRACT

According to one embodiment, an electronic apparatus comprises a display, a deformation module, and a conversion module. The display is configured to display a first object based on display data of a program which executes a predetermined process. The deformation module is configured to deform the first object to a second object in accordance with a user operation. The conversion module is configured to convert a first position designated in the second object to a second position in the first object.

### CROSS-REFERENCE TO RELATED APPLICATIONS

This application is based upon and claims the benefit of priority from prior Japanese Patent Application No. 2010-288820, filed Dec. 24, 2010, the entire contents of which are incorporated herein by reference.

### FIELD

Embodiments described herein relate generally to an electronic apparatus and an object display method.

### BACKGROUND

In general, an electronic apparatus, such as a personal computer, executes an application program, thereby displaying an object corresponding to the application. A user executes an input operation on the object, thus being able to execute a function which is provided in the application.

In addition, in the case where the application program is configured to be capable of deforming the object (e.g. size and display position), the user can execute an input operation on the object by enlarging/reducing the display size of the object which is displayed on the display screen or by moving the display position of the object to a position where an easy use is enabled, so that the input operation may become easier.

However, in the case where the object cannot be deformed, the user has no choice but to execute an input operation on the object of a predetermined shape, which is displayed by the application. In other words, the user cannot execute an input operation by deforming the object in accordance with the user's preference, and therefore the operability cannot be improved.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary external appearance structure of a communication system according to an embodiment.

FIG. 2 is an exemplary state in which a touchpad terminal and a handset are detached from a cradle in the embodiment.

FIG. 3 is an exemplary block diagram showing a system configuration of a touchpad terminal 10 in the embodiment.

FIG. 4 is an exemplary block diagram showing a system configuration of a handset in the embodiment.

FIG. 5 is an exemplary block diagram showing a system configuration of a cradle in the embodiment.

FIG. 6 is an exemplary diagram showing a relationship in connection between the touchpad terminal, handset and cradle in the embodiment.

FIG. 7 is an exemplary view for describing communication paths via the cradle in the embodiment.

FIG. 8 is an exemplary block diagram showing a module configuration by a display program in the embodiment.

FIG. 9 is an exemplary flow chart illustrating an object deforming process in the embodiment.

FIG. 10 shows an example in which an object of a gadget program is displayed in a bulletin display area in the embodiment.

FIG. 11 shows a display example of an object in the embodiment.

FIG. 12 shows a display example of an object in the embodiment.

FIG. 13 shows a display example of an object in the embodiment.

FIG. 14 shows a display example of an object in the embodiment.

FIG. 15 shows an example of stack data in the embodiment.

FIG. 16 is an exemplary flow chart illustrating a position conversion process in the embodiment.

FIG. 17A and FIG. 17B are exemplary diagrams showing a relationship between an object before deformation and an object after deformation in the embodiment.

FIG. 18 is an exemplary diagram showing a relationship between an object before deformation and an object after deformation in the embodiment.

### DETAILED DESCRIPTION

Various embodiments will be described hereinafter with reference to the accompanying drawings.

In general, according to one embodiment, an electronic apparatus comprises a display, a deformation module, and a conversion module. The display is configured to display a first object based on display data of a program which executes a predetermined process. The deformation module is configured to deform the first object to a second object in accordance with a user operation. The conversion module is configured to convert a first position designated in the second object to a second position in the first object.

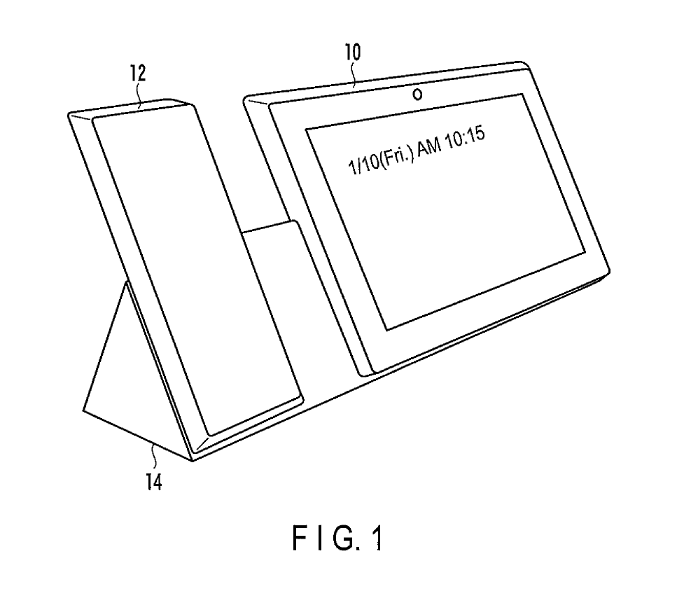

FIG. 1 shows an external appearance structure of a communication system according to the embodiment. The communication system shown in FIG. 1 comprises a touchpad terminal 10, a handset 12 and a cradle 14.

The touchpad terminal 10 and handset 12 are configured to be attachable/detachable to/from the cradle 14. FIG. 1 shows the state in which the touchpad terminal 10 and handset 12 are attached to the cradle 14.

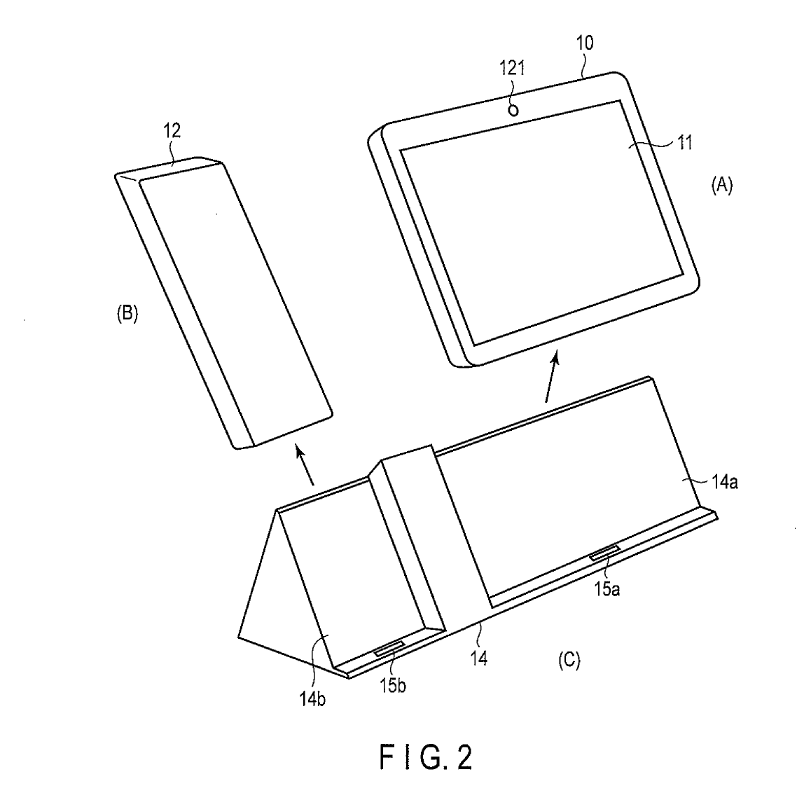

FIG. 2 shows the state in which the touchpad terminal 10 and handset 12 in the embodiment are detached from the cradle 14. As shown in FIG. 2, an attachment part 14a for attaching the touchpad terminal 10 and an attachment part 14b for attaching the handset 12 are formed on the cradle 14.

An inclined surface is formed on the attachment part 14a. The touchpad terminal 10 is disposed such that the back surface of the touchpad terminal 10 is put on the inclined surface of the attachment part 14a. A bottom portion of the attachment part 14a is provided with a power connector 15a, which is connected to a power terminal (not shown) provided on the touchpad terminal 10 when the touchpad terminal 10 is mounted on the cradle 14.

Similarly, an inclined surface is formed on the attachment part 14b. The handset 12 is disposed such that an operation surface of the handset 12 (i.e. a surface opposite to the surface shown in FIG. 2) is put on the inclined surface of the attachment part 14b. A bottom portion of the attachment part 14b is provided with a power connector 15b, which is connected to a power terminal (not shown) provided on the handset 12 when the handset 12 is mounted on the cradle 14. By being mounted on the cradle 14, the touchpad terminal 10 and handset 12 are electrically connected via the power connectors 15a and 15b and can be charged.

The touchpad terminal 10 has functions equivalent to those of a personal computer. The touchpad terminal 10 is an electronic apparatus which can realize various functions by executing an OS (Operating System) and application programs by a processor. The touchpad terminal 10 is not only capable of operating in a stand-alone mode, but is also connectable to some other device via the cradle 14. In addition, the touchpad terminal 10 can be used as a communication terminal which is equipped with a telephone function. The touchpad terminal 10 is provided with a speaker and a microphone for making a speech call. A plurality of kinds of communication modules are implemented in the touchpad terminal 10, and the touchpad terminal 10 can wirelessly communicate with the cradle 14 by the respective communication modules. For example, the touchpad terminal 10 includes a wireless LAN module for wireless LAN (Local Area Network), and a digital cordless telephone module for executing wireless communication according to digital cordless telephone standards. The wireless LAN module is, for instance, a module which makes use of Wi-Fi (trademark). The digital cordless telephone module is, for instance, a module which supports DECT (Digital Enhanced Cordless Telecommunications) standards. The digital cordless telephone module according to the DECT standards uses a frequency band of 1.9 GHz and executes wireless communication by a communication system of TDD-TDMA (autonomous distributed multi-channel access wireless communication). The touchpad terminal 10 is connected to the handset 12 via the cradle 14. In addition, the touchpad terminal 10 is connected via the cradle 14 to a data communication network including the Internet, or a public switched telephone network (PSTN).

The touchpad terminal 10 has a thin box-shaped housing. A touch-screen display 11 is built in a substantially central area of the top surface of the housing. The touch-screen display 11 is configured, for example, such that a touch panel 11A is mounted on the surface of an LCD 11B. The touch-screen display 11 can effect display by the LCD 11B, and can detect a touch position which is touched by a pen or a fingertip. A user can select various objects displayed on the LCD 11B, by using a pen or a fingertip. Objects, which are targets of touch operations by the user, include, for instance, an object which is displayed by an application program, a window for displaying various pieces of information, a software keyboard, a software touchpad, an icon representing a folder or a file, a menu, and a button. The touchpad terminal 10 is equipped with, instead of an input device such as a keyboard or a mouse/touchpad, an application program for inputting data by a touch operation by means of a pen or a fingertip on the touch-screen display 11.

Besides, a camera module 121 for capturing an image is provided on the top surface of the housing of the touchpad terminal 10. Although not shown, the touchpad terminal 10 is provided with a power button for instructing power-on or power-off, various buttons and various connectors.

The handset 12 is a communication terminal which is equipped with a telephone function. The handset 12 is provided with a display and an input device including buttons, as well as a speaker and a microphone for making a speech call. The handset 12 is provided with a digital cordless telephone module which executes wireless communication according to digital cordless telephone standards, and the handset 12 can wirelessly communicate with the cradle 14. For example, DECT is used as the digital cordless telephone standard. The handset 12 is connected to a public switched telephone network (PSTN) via the cradle 14. In addition, the handset 12 is connected to the touchpad terminal 10 via the cradle 14, and has a function of synchronizing data of address book, etc. with the touchpad terminal 10.

The cradle 14 is used as a base on which the touchpad terminal 10 and handset 12 are disposed, and also the cradle 14 functions as an access point of the touchpad terminal 10 and handset 12. The cradle 14 includes a wireless LAN module for wireless LAN, and a digital cordless telephone module for executing wireless communication according to the digital cordless telephone standards. For example, Wi-Fi is used for the wireless LAN. For example, DECT is used as the digital cordless telephone standard. The cradle 14 can wirelessly communicate with the touchpad terminal 10 via the wireless LAN module for wireless LAN or via the digital cordless telephone module. Furthermore, the cradle 14 can wirelessly communicate with the handset 12 via the digital cordless telephone module.

The cradle 14 is connected to an external power supply, and can supply power from the external power supply to the touchpad terminal 10 and handset 12 which are disposed on the attachment parts 14a and 14b. In addition, the cradle 14 has a function of mediating a data process for synchronizing data of an address book, etc. between the touchpad terminal 10 and handset 12. Besides, the cradle 14 connects the touchpad terminal 10 and handset 12 to the data communication network or public switched telephone network (PSTN).

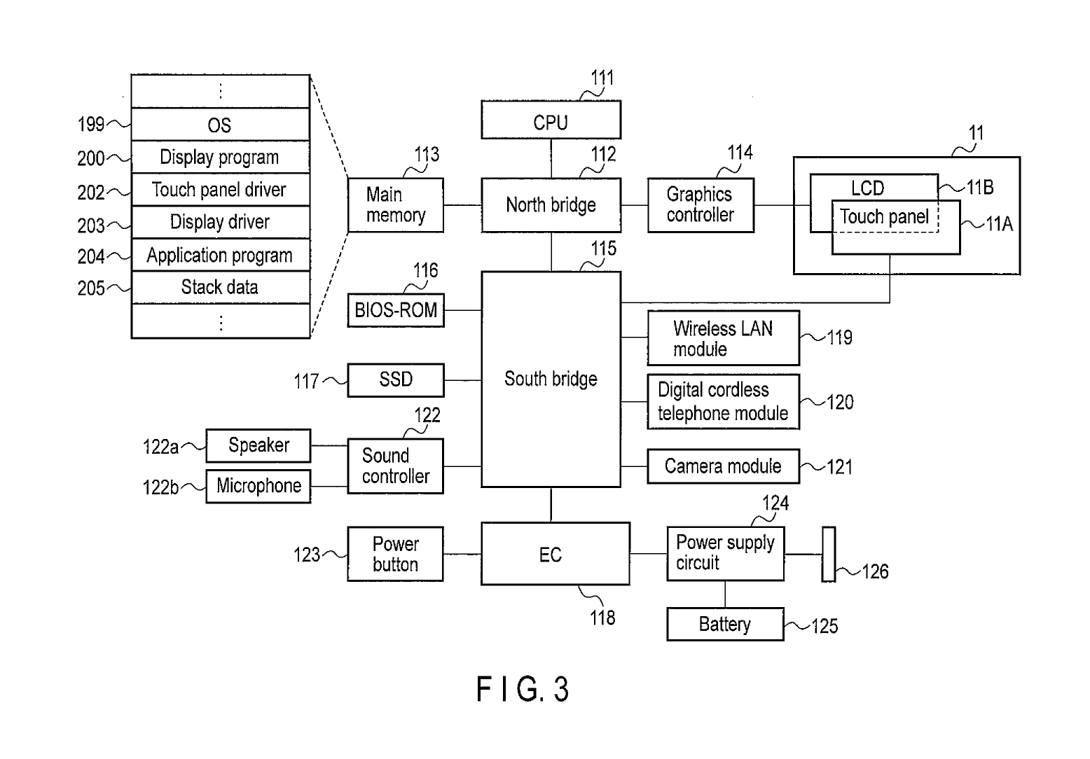

FIG. 3 is a block diagram showing a system configuration of the touchpad terminal 10 in the embodiment.

The touchpad terminal 10 comprises a CPU 111, a north bridge 112, a main memory 113, a graphics controller 114, a south bridge 115, a BIOS-ROM 116, a solid-state drive (SSD) 117, an embedded controller 118, a wireless LAN module 119, a digital cordless telephone module 120, and a camera module 121.

The CPU 111 is a processor which is provided in order to control the operation of the touchpad terminal 10. The CPU 111 executes an operating system (OS) 199, various device drivers, and various application programs, which are loaded from the SSD 117 into the main memory 113. The device drivers include, for example, a touch panel driver 202 which controls the driving of the touch panel 11A under the control of the OS 199, and a display driver 203 which controls display on the LCD 11B under the control of the OS 199. Application programs 204 include an application which is called a gadget application (hereinafter referred to simply as “gadget”) which executes a predetermined specific process, a photo frame program, a browser program, and a word processing program. The gadget is, in general, a single-function program with a specific purpose, such as a clock, a calculator or a calendar. The program of the gadget may be pre-installed in the touchpad terminal 10, or may be installed via a network or an external storage medium.

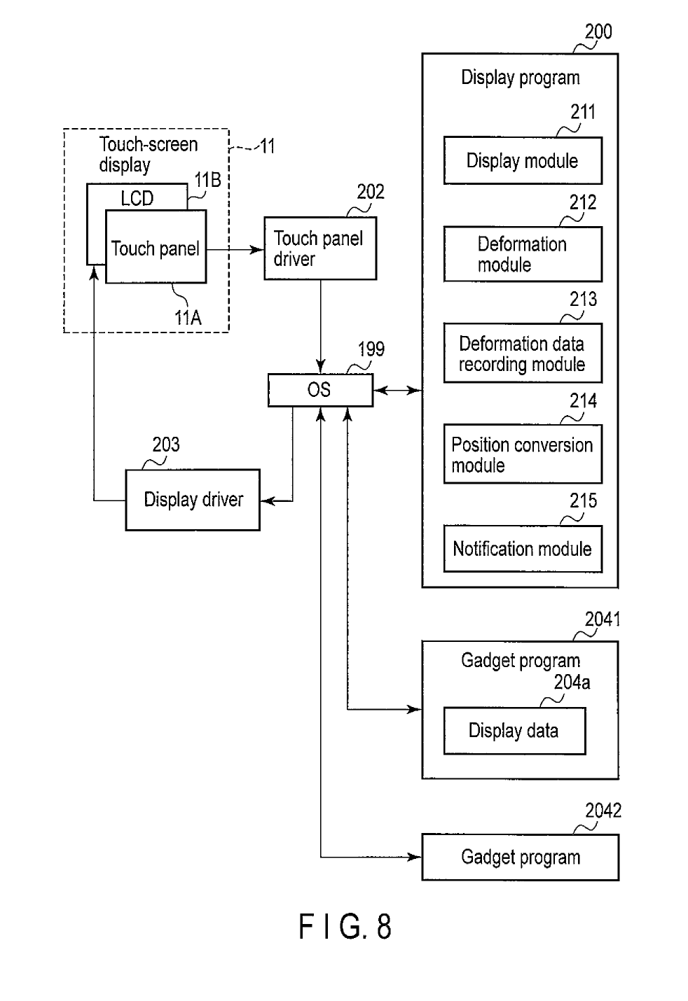

In addition, the application programs include a display program 200 which manages other plural applications batchwise, so that the user may easily operate the applications. The display program 200 displays, in a list form, objects corresponding to the respective application programs within a specific display area, and causes a process, which is designated in association with an object in the display area, to be executed by the corresponding application program. The details of function modules, which are realized by the display program 200, will be described later (FIG. 8). Moreover, the application programs include a program for executing functions of a telephone, FAX, e-mail and TV phone, with use of the touchpad terminal 10.

The CPU 111 also executes a system BIOS (Basic Input/Output System) which is stored in the BIOS-ROM 116. The system BIOS is a program for hardware control.

The north bridge 112 is a bridge device which connects a local bus of the CPU 111 and the south bridge 115. The north bridge 112 includes a memory controller which access-controls the main memory 113. The graphics controller 114 is a display controller which controls the LCD 11B which is used as a display monitor of the touchpad terminal 10.

The graphics controller 114 executes a display process (graphics arithmetic process) for rendering display data on a video memory (VRAM), based on a rendering request which is received from CPU 111 via the north bridge 112. The transparent touch panel 11A is disposed on the display surface of the LCD 11B.

The touch panel 11A is configured to detect a touch position on a touch detection surface by using, for example, a resistive method or a capacitive method. It is assumed that a multi-touch panel, for instance, which can detect two or more touch positions at the same time, is used as the touch panel 11A. The touch panel 11A outputs data, which is detected by the user's touch operation, to the south bridge 115. The south bridge 115 receives data from the touch panel 11A, and records the data in the main memory 113 via the north bridge 112.

The south bridge 115 incorporates a controller, or the like, for controlling the SSD 117. In addition, the embedded controller (EC) 118, wireless LAN module 119, digital cordless telephone module 120, camera module 121 and sound controller (codec) 122 are connected to the south bridge 115.

The EC 118 has a function of powering on/off the touchpad terminal 10 in accordance with the operation of the power button 123 by the user.

The wireless LAN module 119 is, for instance, a module which makes use of Wi-Fi (trademark), and controls wireless communication with the cradle 14.

The digital cordless telephone module 120 is, for instance, a module which supports DECT standards, and controls wireless communication with the cradle 14.

The camera module 121 captures an image under the control of the CPU 111, and inputs image data. The camera module 121 can capture not only still images but also a moving picture.

The sound controller 122 executes a speech signal process for a speech call. The sound controller 122 decodes audio data from the CPU 111 and outputs an analog audio signal to a speaker 122a, and the sound controller 122 encodes an analog audio signal which is input from a microphone 122b, and outputs audio data to the CPU 111.

The power supply circuit 124, in cooperation with the EC 118, controls the power-on/power-off of the touchpad terminal 10. In addition, the power supply circuit 124 generates and supplies operation power to the respective modules by using power from a battery 125 which is mounted in the touchpad terminal 10, or power from an AC adapter (external power supply) which is connected to an external power terminal (not shown) provided on the touchpad terminal 10. Besides, when the touchpad terminal 10 is disposed on the cradle 14, the power supply circuit 124 charges the battery 125 with power which is supplied from the cradle 14 via a power terminal 126.

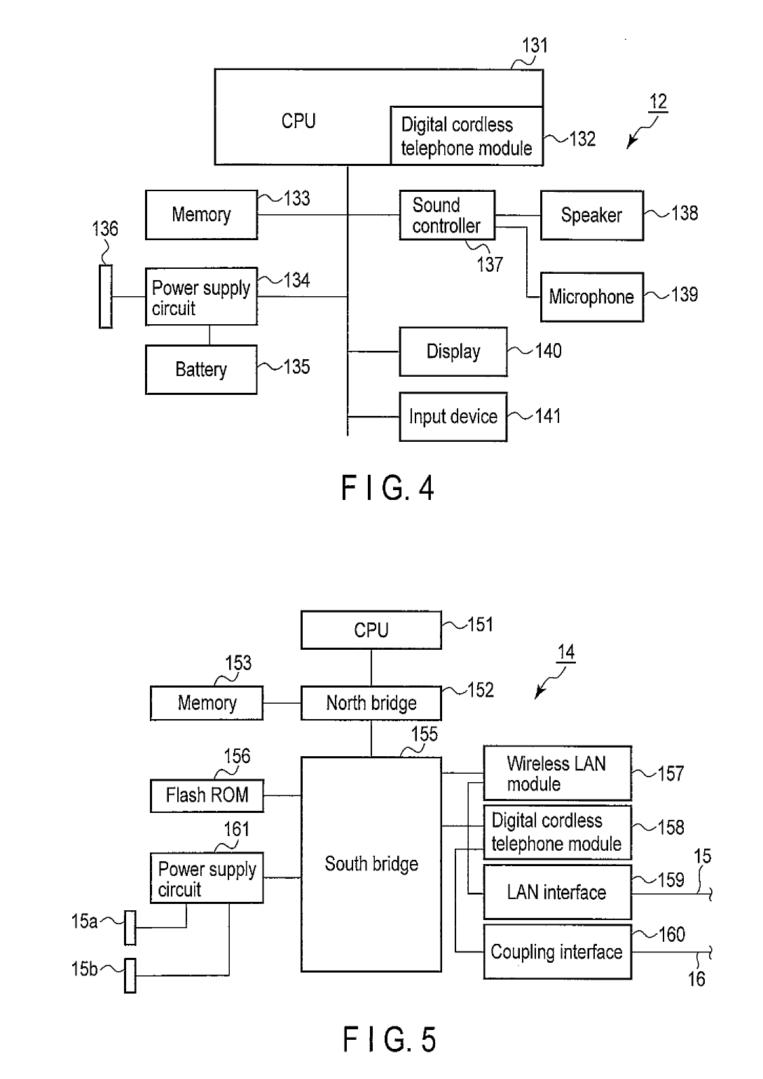

FIG. 4 is a block diagram showing a system configuration of the handset 12 in the embodiment.

The handset 12 comprises a CPU 131, a memory 133, a power supply circuit 134, a battery 135, a power terminal 136, a sound controller (codec) 137, a speaker 138, a microphone 139, a display 140, and an input device 141.

The CPU 131 is a processor for controlling the operation of the handset 12. A digital cordless telephone module 132 is implemented in the CPU 131. The digital cordless telephone module 132 is, for instance, a module which supports DECT standards, and controls wireless communication with the cradle 14.

The memory 133 stores various programs and data.

The power supply circuit 134 generates and supplies operation power to the respective components of the handset 12 by using power from the battery 135. When the handset 12 is mounted on the cradle 14, the power supply circuit 134 charges the battery 135 with power which is supplied from the cradle 14 via the power terminal 136.

The sound controller (codec) 137 executes a speech signal process for a speech call. The sound controller 137 decodes audio data from the CPU 131 and outputs an analog audio signal to the speaker 138, and the sound controller 137 encodes an analog audio signal which is input from the microphone 139, and outputs audio data to the CPU 131.

The display unit 140 displays various information, for example, by an LCD (Liquid Crystal Display), under the control of the CPU 131.

The input device 141 is a device for accepting a user operation, and includes a plurality of buttons. The buttons include, for instance, a dial button (character button) and a plurality of function buttons. The function buttons include, for instance, a transmission button, an end button, a power button, a sound volume button, and a cursor button.

FIG. 5 is a block diagram showing a system configuration of the cradle 14 in the embodiment.

The cradle 14 comprises a CPU 151, a north bridge 152, a memory 153, a south bridge 155, a flash ROM 156, a wireless LAN module 157, a digital cordless telephone module 158, a LAN interface 159, a coupling interface (DAA: Direct Access Arrangements) 160, and a power supply circuit 161.

The CPU 151 is a processor which is provided in order to control the operation of the cradle 14. The CPU 151 executes a program which is loaded in the memory 153. By executing the program, the CPU 151 operates as an access point of the touchpad terminal 10 and handset 12, and executes a process for mediating a process (e.g. data synchronization) which is executed cooperatively between the touchpad terminal 10 and handset 12.

The north bridge 152 is a bridge device which connects a local bus of the CPU 151 and the south bridge 155.

The south bridge 155 connects each module and the north bridge 152.

The flash ROM 156 stores programs and data.

The wireless LAN module 157 is, for instance, a module which makes use of Wi-Fi (trademark), and controls wireless communication with the touchpad terminal 10.

The digital cordless telephone module 158 is, for instance, a module which supports DECT standards, and controls wireless communication with the touchpad terminal 10 and handset 12.

The LAN interface 159 is an interface for connecting the wireless LAN module 157 and LAN cable 15. The LAN cable 15 is connected to the LAN interface 159 by RJ-45 (connector) 159.

The coupling interface 160 is an interface for connecting the digital cordless telephone module 158 and a telephone cable 16. The telephone cable 16 is connected to the coupling interface 160 by RJ-11 (connector) 160.

The power supply circuit 161 is connected to an external power supply (not shown) and generates and supplies operation power to the respective modules. When the touchpad terminal 10 is mounted on the cradle 14, the power supply circuit 161 supplies power to the touchpad terminal 10 via the power connector 15a. In addition, when the handset 12 is mounted on the cradle 14, the power supply circuit 161 supplies power to the handset 12 via the power connector 15b.

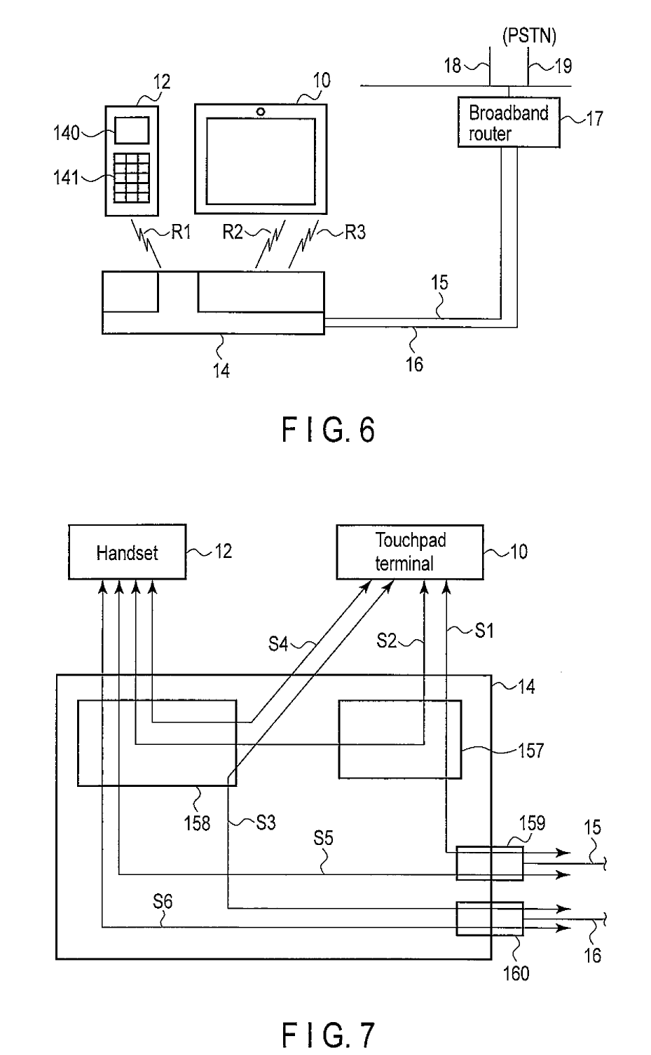

FIG. 6 shows a relationship in connection between the touchpad terminal 10, handset 12 and cradle 14 in the embodiment.

As shown in FIG. 6, the handset 12 and cradle 14 are connected by wireless communication (R1) according to digital cordless telephone standards. The touchpad terminal 10 and cradle 14 are connected by wireless communication (R2) according to digital cordless telephone standards and by wireless communication (R3) by wireless LAN.

The LAN cable 15 and telephone cable 16, which are connected to the cradle 14, are connected to a broadband router 17. A cable 18 (e.g. optical cable) for connection to a data communication network (including the Internet) and a telephone cable 19 for connection to a public switched telephone network (PSTN) are connected to the broadband router 17. Accordingly, the cradle 14 is connected to the external network (data communication network, public switched telephone network) via the broadband router 17.

FIG. 7 is a view for describing communication paths via the cradle 14 in the embodiment.

As shown in FIG. 7, a communication path S1 is a path though which the touchpad terminal 10 and cradle 14 are connected by wireless LAN (wireless communication R3) and the cradle 14 is connected to the data communication network via the LAN cable 15. A communication path S2 is a path through which the touchpad terminal 10 and cradle 14 are connected by the wireless LAN (wireless communication R3) and the handset 12 and cradle 14 are connected by the wireless communication R1, whereby the touchpad terminal 10 and handset 12 are connected. A communication path S3 is a path through which the touchpad terminal 10 and cradle 14 are connected by the wireless communication R2 and the cradle 14 is connected to the public switched telephone network via the telephone cable 16. A communication path S4 is a path through which the touchpad terminal 10 and cradle 14 are connected by the wireless communication R2 and the handset 12 and cradle 14 are connected by the wireless communication R1, whereby the touchpad terminal 10 and handset 12 are connected. A communication path S5 is a path through which the handset 12 is connected to the cradle 14 by the wireless communication R1 and the cradle 14 is connected to the data communication network via the LAN cable 15. A communication path S6 is a path through which the handset 12 is connected to the cradle 14 by the wireless communication R1 and the cradle 14 is connected to the public switched telephone network via the telephone cable 16.

One of the communication paths S1 to S6 is used in accordance with a process which is executed by the touchpad terminal 10 and handset 12.

Next, a description is given of a module configuration which is realized by the display control program 200 of the touchpad terminal 10 in the embodiment. FIG. 8 is a block diagram showing the module configuration by the display program 200 in the embodiment.

The display program 200 displays, in a list form, objects corresponding to the respective application programs (e.g. gadget programs 2041, 2042, . . . ) in a specific display area, and causes a process, which is designated in association with an object in the display area, to be executed by the corresponding application program.

The application programs include not only an application program which is embedded in a part of the display program 200, but also an application program which independently operates irrespective of the display program 200. It is assumed that the gadget programs 2041 and 2042 shown in FIG. 8 are application programs which are created, for example, irrespective of the display program 200, and are installed in the touchpad terminal 10 by, e.g. download. It is also assumed that when the gadget program 2041, 2042 displays an object, the size and direction of the object are fixed.

Thus, when the gadget program 2041, 2042 operates independently and displays an object, the deformation (enlargement/reduction, rotation) of the object cannot be executed. In the object displayed by the gadget program 2041, 2042, a process, which is to be executed in accordance with a position (area) designated by a user operation, is defined. By discriminating the designated position in the object, the gadget program 2041, 2042 executes the process corresponding to the designated position.

Even when the size and direction of the object, which is displayed by the gadget program 2041, 2042, are fixed, the display program 200 displays, in a list form, the object of the gadget program 2041, 2042 in a specific display area (hereinafter referred to as “bulletin display area”) which is set on the display screen, thereby enabling deformation of the object in the bulletin display area.

The display program 200 receives touch position information indicative of a touch position on the touch panel 11A via the touch panel driver 202 and the OS 199, and executes deformation (enlargement/reduction, move, rotation) of the object, based on the touch position information. In addition, the display program 200 converts the touch position of the deformed object to a touch position on the original object before the deformation, and notifies the touch position to the application. The application executes a process corresponding to the touch position on the object, which has been notified by the display program 200.

The display control program 200 comprises a display module 211, a deformation module 212, a deformation data recording module 213, a position conversion module 214 and a notification module 215.

The display module 211 displays an object in a bulletin display area, based on display data of an application program which executes a predetermined process. For example, when the gadget program 2041 is managed by the display program 200, the display module 211 captures display data 204a of the gadget program 2041 and displays an object corresponding to the display data 204a in the bulletin display area. For example, when the object is displayed by the gadget program 2041, if a user operation (e.g. drag-and-drop operation) has been executed to move the object into the bulletin display area which is displayed by the display program 200, the display module 211 captures the display data 204a of the object and displays the object in the bulletin display area.

The deformation module 212 deforms the object, which is displayed by the display module 211, in accordance with the user operation. The deformation module 212 is configured to be able to execute, for example, at least one of deformations, i.e. enlargement/reduction, move and rotation, on the object. The deformation module 212 may be configured to be able to execute other deformations. The deformation module 212 executes the deformation of the object in the bulletin display area. It is assumed that when a user operation has been executed to shift the object out of the bulletin display area, the object (gadget program 2041) is released from the management by the display program 200. The deformation module 212 can execute the deformation on the object in a plurality of steps in accordance with the user operation. For example, the deformation module 212 can successively execute deformations of enlargement, move and rotation on the object in a stepwise manner. Specifically, the user can use the object by arbitrarily deforming the position of the object in the bulletin display area, depending on conditions.

The deformation data recording module 213 records deformation data indicative of a deformation amount of the object which has been deformed by the deformation module 212, that is, deformation data which defines the relationship between the object before deformation and the object after deformation. In the present embodiment, the deformation data is defined as deformation matrix (the details will be described later). When the deformation on the object has been executed in a plurality of steps, the deformation data recording module 213 stacks deformation data (deformation matrix data) each time deformation has been executed in each of the steps.

The position conversion module 214 converts a position (first position), which is designated in the object that has been deformed by the deformation module 212, to a position (second position) in the object before the deformation. The position conversion module 214 calculates the second position by reversely converting the first position, based on the deformation data recorded by the deformation data recording module 213.

The notification module 215 notifies the second position, which has been calculated by the conversion by the position conversion module 214, that is, the position designated on the object, to the application program (e.g. gadget program 2041) corresponding to the object. Specifically, the notification module 215 causes the application program to execute the process corresponding to the designated position, by notifying the designated position on the object to the application program.

Next, a description is given of the operation of the display program 200 of the touchpad terminal 10 in the embodiment.

The display program 200, if started, displays the bulletin display area in the display screen of the LCD 11B. A menu area (see FIG. 10), in which a plurality of buttons for executing various functions provided in the display program 200, is added to the bulletin display area. When a gadget button provided in the menu area has been designated by a user operation (touch operation), the display program 200 displays in the bulletin display area the object by the gadget program which is embedded as a part of the functions of the display program 200.

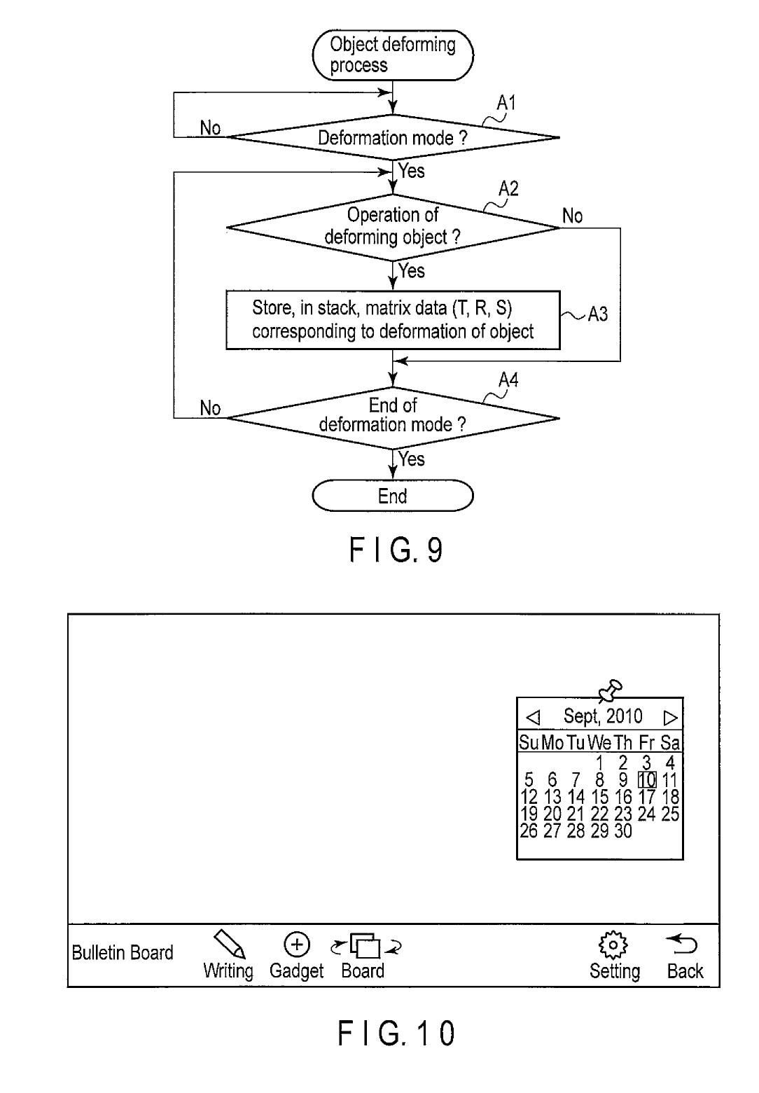

This object can arbitrarily be deformed in the bulletin display area. As regards the gadget program, which is embedded as a part of the functions of the display program 200, since the display program 200 can discriminate the process which is to be executed in accordance with the position designated on the object after deformation, there is no need to execute an object deformation process (FIG. 9) or a position conversion process (FIG. 16), which will be described later.

The description below is directed to the gadget program 2041 which is installed irrespective of the display program 200.

The gadget program 2041, if started, displays the corresponding object on the LCD 11B. If the object is moved into the bulletin display area by a user operation (drag-and-drop operation), the display module 211 of the display program 200 captures the object which is displayed based on the display data 204a of the gadget program 2041, and displays the object in the bulletin display area. The display module 211 stores the initial position of the object displayed in the bulletin display area.

FIG. 10 shows an example in which the object of the gadget program 2041 is displayed in the bulletin display area. As shown in FIG. 10, the gadget program 2041 is an application program which displays a calendar. In the object representative of the calendar, for example, by designating an area indicative of an arrow, the display of the calendar can be changed to a previous “month” or a next “month”. In addition, by designating an area corresponding to a “day” in the calendar, data which is recorded in association with the “day” can be displayed.

To begin with, referring to a flow chart of FIG. 9, a description is given of an object deformation process in the case of deforming an object which is displayed in the bulletin display area.

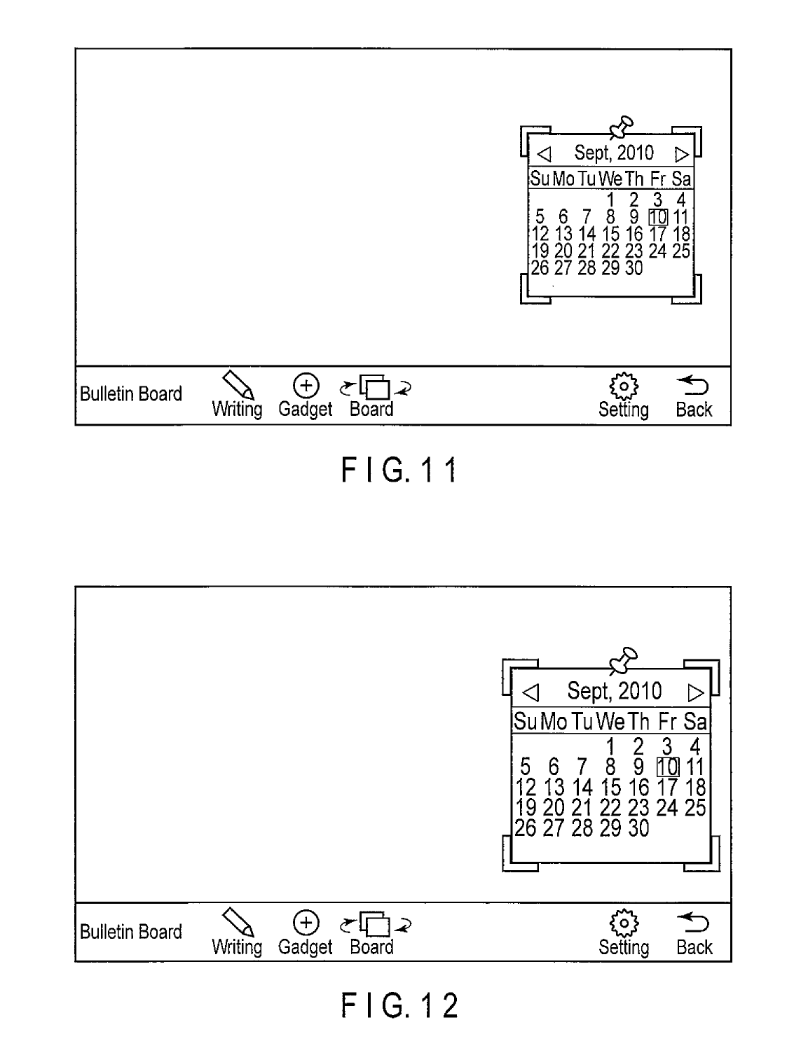

When the object is pressed for a long time (an operation in which the state of a touch on the object is continued for a predetermined time or more), the deformation module 212 sets a deformation mode for this object (Yes in block A1). For example, as shown in FIG. 11, the deformation module 212 displays operation marks at the four corners of the object, so as to indicate that the deformation mode has been set. The user can instruct deformation of enlargement/reduction or rotation of the object, by touching and moving the object operation marks.

For example, the object can be enlarged/reduced by moving the operation mark in a direction away from or toward the center of the object. In addition, the object can be rotated by moving the operation mark in a direction crossing a direction toward the center of the object. By touching and moving an arbitrary position of the object for which the deformation mode is set, the object can be moved in accordance with the movement of the touch position.

Assume now that the user has executed an operation of enlarging, for example, an object shown in FIG. 11. In accordance with the user operation, the deformation module 212 displays the object by enlarging it. FIG. 12 shows a display example in which the enlarged object is displayed. For example, the deformation module 212 enlarges the object in accordance with the user operation (the movement amount of the touch position) with reference to the display position of a pin added to the object (the pin being provided at the center of the upper side of the object).

If the operation of deforming the object is executed (Yes in block A2), the deformation data recording module 213 records deformation data indicative of a deformation amount of the object which has been deformed by the deformation module 212, that is, deformation data which defines the relationship between the object before deformation and the object after deformation (block A3). In the present embodiment, the deformation data is defined as deformation matrix data.

For example, in the present embodiment, the deformation matrix data relating to “move” is represented by a deformation matrix T, the deformation matrix data relating to “rotation” is represented by a deformation matrix R, and the deformation matrix data relating to “enlargement/reduction” is represented by a deformation matrix S:

T={[1,0,x][0,1,y][0,0,1]}

R={[cos θ,−sin θ,0][sin θ,cos θ,0][0,0,1]}

S={[s,0,0][0,s,0][0,0,1]}.

In the equations, “x” and “y” in the deformation matrix T indicate the coordinate amount of movement of the object in the xy coordinate system, “θ” in the deformation matrix R indicates the angle of rotation of the object, and “s” in the deformation matrix S indicates the scale of enlargement/reduction of the object.

Even in the case where only enlargement has been executed on the object, the deformation data recording module 213 records a matrix M which is calculated from the respective deformation matrices T, R and S, or by integrating the deformation matrices T, R and S.

An example of the deformation matrix is shown below. This is an example of the deformation matrix in the case where the object has been moved. In this case, the deformation amount of each deformation is expressed, for example, by:

Move: x=−415.0, y=26.0

Angle of rotation=0.0

Enlargement/reduction scale=1.0.

If the original matrix is {[1.0, 0.0, 0.0] [0.0, 1.0, 0.0] [0.0, 0.0, 1.0]}, the deformation matrices T, R and S corresponding to the deformation (only “move” in this case) are as follows:

T={[1.0,0.0,−415.0][0.0,1.0,26.0][0.0,0.0,1.0]}

R={[1.0,0.0,0.0][0.0,1.0,0.0][0.0, 0.0,1.0]}

S={[1.0,0.0,0.0][0.0,1.0,0.0][0.0,0.0,1.0]}.

In this case, a matrix M representing the product of the deformation matrices T, R and S is:

M=T×R×S={[1,0,−415.0][0.0,1.0,26.0][0.0,0.0,1.0]}

A matrix, which is obtained by subjecting the deformation matrix M to inverse matrix conversion, is:

M⁻¹={[1.0,−0.0,−155.0] [−0.0,1.0,−107.0][0.0,0.0,1.0]}.

The deformation data recording module 213 records the deformation matrices T, R and S, or the deformation matrix M, as stack data 205.

The deformation mode is finished, for example, when an area other than the object has been touched. If the deformation mode is not finished (No in block A4), the deformation module 212 deforms the object in accordance with a user operation when the user operation has been executed to deform the object, in the same manner as described above. The deformation data recording module 213 stacks the deformation matrix data corresponding to the deformation amount, each time the object is deformed by the user operation (block A3).

In the meantime, since the deformation in the second step is additional deformation to the previous deformation, a matrix M2 is calculated by integrating the present deformation matrices T2, R2 and S2 with the previous matrix M1. As regards the deformation in an n-th step and the following, a matrix Mn is similarly calculated.

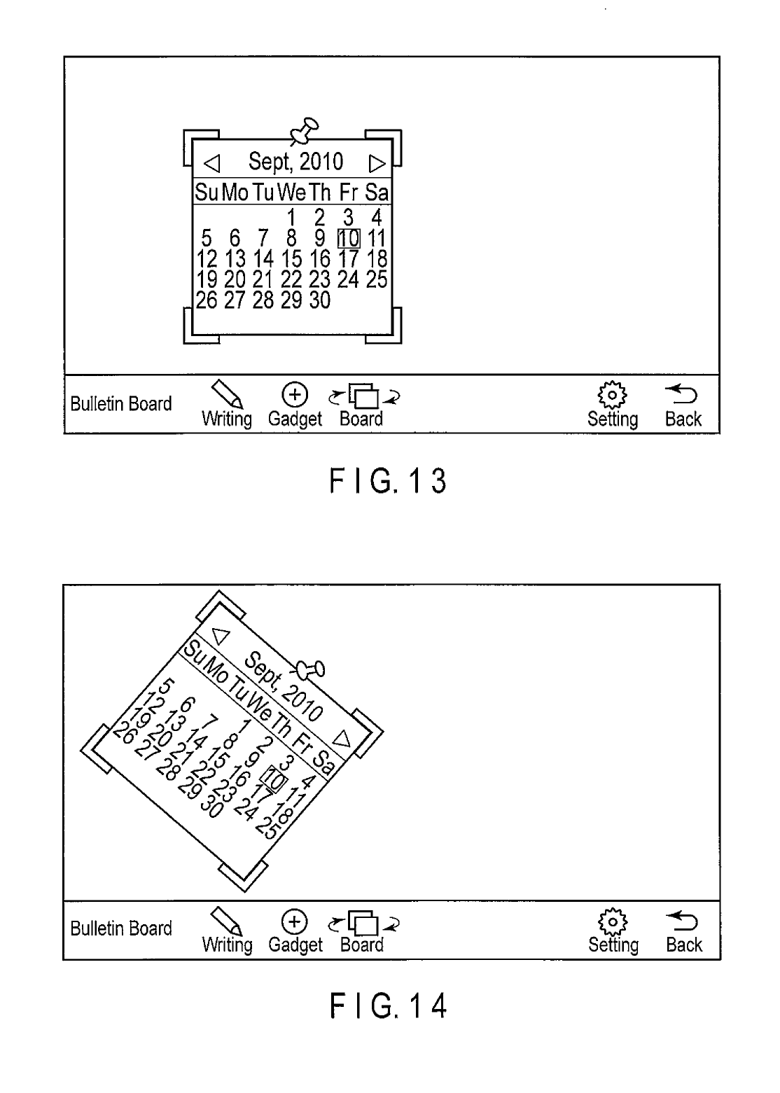

FIG. 13 shows a display example in which the object shown in FIG. 12 has been moved. FIG. 14 shows a display example in which the object shown in FIG. 13 has been rotated.

When the object has been deformed in a plurality of steps in this manner, the deformation data recording module 213 stacks the deformation matrices T, R and S or the deformation matrix M corresponding to the deformation of each step.

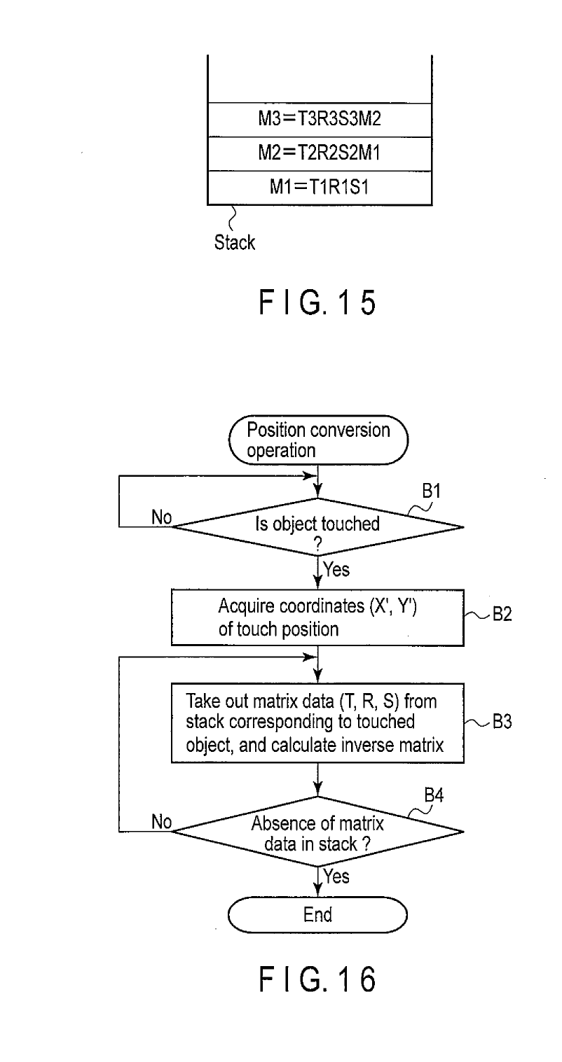

FIG. 15 shows an example of the stack data 205 in the case where the object has been subjected to the deformation of enlargement, move and rotation in the bulletin display area, as shown in FIG. 11 to FIG. 14. As shown in FIG. 15, each time the deformation of enlargement, move or rotation is executed, the deformation matrix M1 (T1×R1×S1), deformation matrix M2 (T2×R2×S2×M1) and deformation matrix M3 (T3×R3×S3×M2) are stacked.

In the case where a plurality of objects (e.g. objects of gadget program 2042) are displayed in the bulletin display area, it is assumed that stack data corresponding to the deformation of each object is recorded.

Next, referring to a flow chart of FIG. 16, a description is given of a position conversion process for converting a touch position designated on an object after deformation.

If a touch operation has been executed in the area of the object displayed in the bulletin display area (Yes in block B1), the position conversion module 214 acquires coordinates (x′, y′) of the touch position, that is, the position designated on the object (block B2).

The position conversion module 214 successively takes out the deformation matrix data from the stack data corresponding to the touched object, and calculates an inverse matrix (block B3, B4). Then, based on the inverse matrix of the deformation matrix, the position conversion module 214 calculates the position of the object at the initial position, which corresponds to the coordinates (x′, y′) of the position designated on the object after deformation.

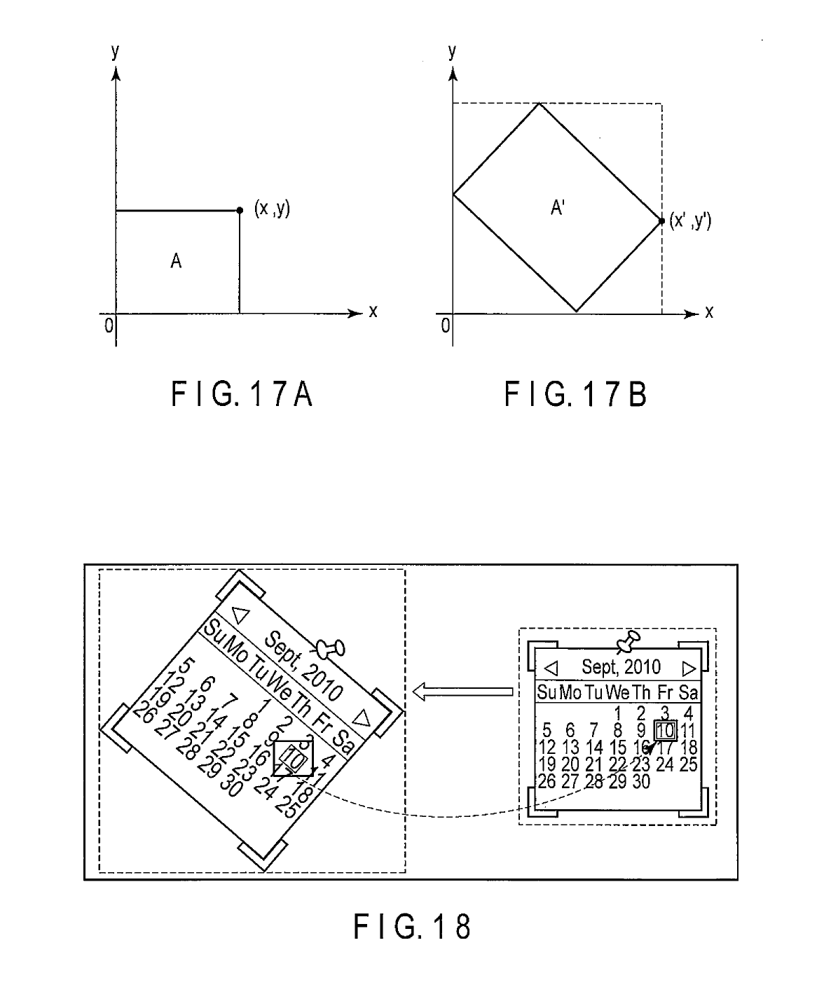

FIG. 17A and FIG. 17B show an object A at an initial position before deformation, and an object A′ after deformation. The coordinates of the object A, which correspond to the coordinates (x′, y′) shown in FIG. 17A and FIG. 17B, are (x, y). The position conversion module 214 converts the coordinates (x′, y′) to the coordinates (x, y), based on the deformation matrix of the inverse matrix. The coordinates (x, y) are calculated in the following manner.

$$\begin{matrix}[ \begin{matrix}{x}^{′} \\ {y}^{′}\end{matrix} ] = M 3 [ \begin{matrix}x \\ y\end{matrix} ] & ( 1 ) \\ [ \begin{matrix}x \\ y\end{matrix} ] = M {3}^{- 1} [ \begin{matrix}{x}^{′} \\ {y}^{′}\end{matrix} ] & ( 2 ) \\ [ \begin{matrix}x \\ y\end{matrix} ] = M {2}^{- 1} {( T 3 R 3 S 3 )}^{- 1} [ \begin{matrix}{x}^{′} \\ {y}^{′}\end{matrix} ] & ( 3 ) \\ [ \begin{matrix}x \\ y\end{matrix} ] = M {1}^{- 1} {( T 2 R 2 S 2 )}^{- 1} \cdot {( T 3 R3S 3 )}^{- 1} [ \begin{matrix}{x}^{′} \\ {y}^{′}\end{matrix} ] & ( 4 ) \\ [ \begin{matrix}x \\ y\end{matrix} ] = {( T 1 R 1 S 1 )}^{- 1} \cdot {( T 2 R 2 S 2 )}^{- 1} \cdot {( T 3 R 3 S 3 )}^{- 1} [ \begin{matrix}{x}^{′} \\ {y}^{′}\end{matrix} ] & ( 5 )\end{matrix}$$

By this position conversion process, the position designated on the object after deformation is converted to the position on the object at the initial position. For example, if a position of display of “10” is touched on an object which is shown in a left side of FIG. 18 and which has been deformed by enlargement, move and rotation, this touch position is converted to a position of display of “10” on an object at an initial position shown in a right side of FIG. 18.

When the position designated on the object has been converted by the position conversion process, the notification module 215 notifies the converted position to the gadget program 2041 which displays the object of the touched calendar. Responding to the notification from the notification module 215, the gadget program 2041 executes a process in a case of designation of the position of “10”, for example, a process of displaying data which is recorded in association with “10th day”.

In this manner, in the touchpad terminal 10 according to the present embodiment, the display program 200 is executed, and thereby objects of other application programs (gadget program 2041, 2042) can be displayed in a list form in the bulletin display area. Thereby, even if the size and direction of the object are fixed in the gadget program 2041, 2042, the object can arbitrarily be deformed in the bulletin display area. The position designated on the object, which has been deformed in the bulletin display area, is converted to the position on the object before deformation, and the converted position is notified to the application program. It is thus possible to execute the same process as in the case where the application program is independently executed.

The above description is directed to the case in which the touch-screen display 11 is provided and the user executes a touch operation on the touch panel 11A to designate the object displayed on the LCD 11B. Also in the case where a user operation is performed by using other pointing devices, the same process as described above can be executed.

The case, by way of example, has been described in which the object is displayed on the touchpad terminal 10 (electronic apparatus) provided in the system shown in FIG. 1. However, the embodiment can be realized in other electronic apparatuses, such as a personal computer, a mobile phone, and a car navigation system.

The process that has been described in connection with the present embodiment may be stored as a computer-executable program in a recording medium such as a magnetic disk (e.g. a flexible disk, a hard disk), an optical disk (e.g. a CD-ROM, a DVD) or a semiconductor memory, and may be provided to various apparatuses. The program may be transmitted via communication media and provided to various apparatuses. The computer reads the program that is stored in the recording medium or receives the program via the communication media. The operation of the apparatus is controlled by the program, thereby executing the above-described process.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a display configured to display a first object based on display data of a program, wherein the program executes a predetermined process;
a deformation module configured to deform the first object to a second object in accordance with a user operation; and
a conversion module configured to convert a first position designated in the second object to a second position in the first object.

2. The electronic apparatus of claim 1, further comprising a recording module configured to record deformation data indicative of an amount of deformation from the first object to the second object,
wherein the conversion module is configured to convert the first position to the second position, based on the deformation data.

3. The electronic apparatus of claim 1, further comprising a notification module configured to notify the second position to the program.

4. The electronic apparatus of claim 1, wherein the deformation module is configured to execute deformation of at least one of enlargement/reduction movement and rotation.

5. The electronic apparatus of claim 1, wherein the display is configured to display the first object in a specific display area, the display area on a display screen, and
the deformation module is configured to deform the first object to the second object in the specific display area.

6. The electronic apparatus of claim 2, wherein the deformation module is configured to deform the first object to the second object in a plurality of steps in accordance with the user operation,
the recording module is configured to stack a plurality of deformation data corresponding to deformations in the plurality of steps, and
the conversion module is configured to convert the first position to the second position in accordance with the plurality of deformation data.

7. An object display method comprising:
displaying a first object based on display data of a program, wherein the program executes a predetermined process;
deforming the first object to a second object in accordance with a user operation; and
converting a first position designated in the second object to a second position in the first object.

8. The object display method of claim 7, further comprising recording deformation data indicative of an amount of deformation from the first object to the second object; and
converting the first position to the second position based on the deformation data.

9. The object display method of claim 7, further comprising notifying the second position to the program.

10. The object display method of claim 7, wherein the deforming comprises executing deformation of at least one of enlargement/reduction, move and rotation.

11. The object display method of claim 7, further comprising displaying the first object in a specific display area which is set on a display screen; and
deforming the first object to the second object in the specific display area.

12. The object display method of claim 8, further comprising deforming the first object to the second object in a plurality of steps in accordance with the user operation;
stacking a plurality of deformation data corresponding to deformations in the plurality of steps; and
converting the first position to the second position in accordance with the plurality of deformation data.

13. A non-transitory computer readable medium having stored thereon a computer program which is executable by a computer, the computer program controlling the computer to execute functions of:
displaying a first object based on display data of a program, wherein the program executes a predetermined process;
deforming the first object to a second object in accordance with a user operation; and
converting a first position designated in the second object to a second position in the first object.
